(19) United States
(12) Patent Application Publication
(10) Pub. No.: US 2003/0223736 A1
(43) Pub. Date: Dec. 4, 2003

(54) DVD player with enhanced connectivity

(76) Inventors: Rehan Muzaffer, El Camino Village, CA (US); Long Fen Ji, Rowland Heights, CA (US); Ancle Ann Keh Hsu, West Covina, CA (US)

Correspondence Address: O'MELVENY & MYERS LLP, 400 So. Hope Street, Los Angeles, CA, 90071-2899, US

(21) Appl. No.: 10/158,622

(22) Filed: May 29, 2002

(51) Int. Cl. H04N 5/781

(52) U.S. Cl. 386/125; 386/126

(57) ABSTRACT

A DVD player that contains a connection adapter that allows the DVD player to support a high speed data transfer port is disclosed. In one exemplary embodiment, the connection adapter provides a USB adapter that provides the DVD player with a USB port. The USB port allows the DVD player to connect with a USB device. In another exemplary embodiment, the connection adapter provides an Ethernet adapter that allows the DVD player to have an Ethernet port. The DVD player may be connected to a network via the Ethernet port. Accordingly, the DVD player may receive or transfer data through the network.

### BACKGROUND OF THE INVENTION

1. Field of the Invention

The present invention relates to a DVD (digital versatile disk) player, and more particularly, to a DVD player that is operable to connect to a USB (universal serial bus) device, a network, or both.

2. Description of the Related Art

With advancements in electronics and growing consumer savvy, the number and variety of consumer electronic devices continue to grow. Many of these devices serve as components in a user's home entertainment system. Because it is important to provide the user with an integrated multimedia experience, the utility of each new device may be defined, in part, by its ability to interact with other devices. Otherwise, the user risks having a collection of devices that are isolated rather than part of a cohesive multi-media system. Accordingly, there is a need for a device that can provide a hub for a user's home entertainment system by interacting with a variety of devices. Conventional computer systems and DVD players are inadequate for providing a hub for a home entertainment system.

Conventional DVD players may play a wide variety of disks including DVD (digital versatile disk), CD, VCD and many other formats. The DVD is a popular format for movies because of its ability to store an entire movie on a single disk with high definition and without a loss in quality from repeated viewings. A conventional DVD player is designed for the sole purpose of playing an optical disk. As a result, DVD players are relatively inexpensive and easy to operate. Because of these qualities, DVD players are commonplace in home entertainment systems. As part of a home entertainment system, conventional DVD players are generally found in the user's family room or den. Family rooms and dens are well suited to a home entertainment system that includes a DVD player, because these rooms are central, comfortable environments that are designed for entertaining groups of people. Therefore, the conventional DVD player allows for several viewers to enjoy a movie when the DVD player is connected to the home entertainment system's television set.

Although DVD players are suitable for providing multi-viewer entertainment, DVD players cannot be considered the hub of a home entertainment system. Conventional DVD players are able to interact with only a limited number of devices. Conventional DVD players generally connect with only televisions and, occasionally, audio devices. Furthermore, conventional DVD players typically only connect with devices that serve as a destination for an audio/visual signal, rather than devices that may serve as a source for a signal. The only input source for a conventional DVD player is generally the DVD disk itself. As a result, conventional DVD players are not capable of interacting with other consumer electronics devices.

Personal computer systems are designed to perform multiple functions and handle a wide variety of software applications. For example, the typical computer system provides e-mail, internet access, spreadsheets, word processors, electronic publishing, graphics and design applications and videogames, among other examples. Accordingly, conventional computer systems require sophisticated hardware and a complex operating system. As a result, in comparison to specialized consumer electronics devices, computer systems are relatively more expensive and complex, suffer more compatibility conflicts with respect to both hardware and software, are generally slower and require a long boot-time, among other disadvantages. For these reasons, it would be impractical to incorporate a computer system into a home entertainment system.

Furthermore, computer systems are not suitable for home entertainment systems, because a computer is typically designed for use by an individual, rather than a group. Conventional computer systems are generally used in home offices. Unlike a den or family room, home offices are typically designed to allow an individual to work rather than provide a space for a group to be entertained. Furthermore, computer systems usually employ monitors that are much smaller than conventional televisions and may be comfortably viewed by only an individual rather than a group of people. In addition, users generally connect stereo systems and speakers to television sets rather than computer systems. As a result, a computer system typically provides an unsatisfactory viewing experience, especially for groups, in comparison with a television. Thus, while computer systems may be suitable for interfacing with a variety of devices, computer systems are not suited for serving as a hub for a home entertainment system.

### SUMMARY OF THE INVENTION

The present disclosure provides a DVD player that contains a connection adapter that allows the DVD player to support a high speed data transfer port. In one exemplary embodiment of the present invention, the connection adapter provides a USB adapter that provides the DVD player with a USB port. The USB port allows the DVD player to connect with a USB device such as a digital camera and a printer, among other examples.

In another exemplary embodiment of the present invention, the connection adapter provides an Ethernet adapter that allows the DVD player to have an Ethernet port. The DVD player may be connected to a network via the Ethernet port. Accordingly, the DVD player may receive or transfer audio and video data, e.g., movies and digital images, through the network.

### BRIEF DESCRIPTION OF THE DRAWINGS

The present disclosure and its numerous objects, features, and advantages may be better understood by reference to the following description of an illustrative embodiment, taken in conjunction with the accompanying drawings, in which:

FIG. 1 is an exemplary embodiment of the DVD player of the present disclosure;

FIG. 2 is a block diagram of an exemplary embodiment of the DVD player; and

FIG. 3 is a block diagram of the software structure for an exemplary embodiment of the DVD player.

### DETAILED DESCRIPTION

The following disclosure is directed towards a DVD (digital versatile disk) player that includes a connection adapter to allow the DVD player to be connected to other multimedia devices, a network, or both. More particularly, in one exemplary embodiment of the present disclosure, the DVD player may accept inputs from external electronic devices using a USB (universal serial bus) connection. In addition the DVD player is capable of communicating with external devices via the USB connection. In another exemplary embodiment, the DVD player contains a network port, such as an Ethernet port for example, to allow the DVD player to send and receive video and audio data, such as movies or images, over a network.

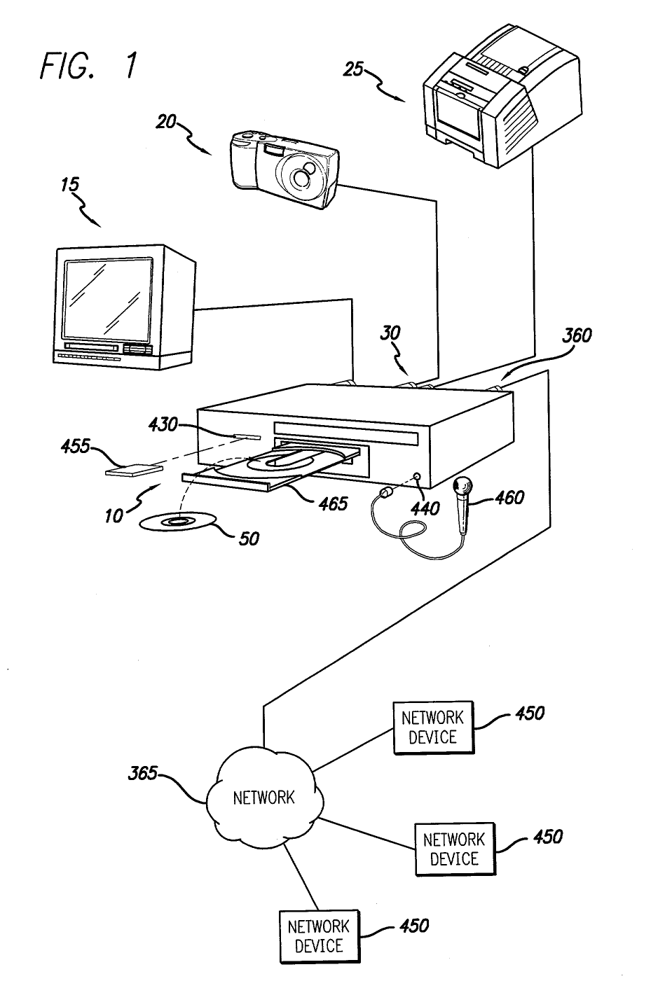

FIG. 1 shows examples of external electronic devices that may be connected to an exemplary embodiment of the present invention. DVD player 10 may play an optical disk 50 via disk drive 465. For example, DVD player 10 is operable to play a DVD and may be operable to play or view iDVD, DVD-R, DVD-RW, DVD-ROM, DVD-RAM, DVD-RW, DVD-Audio, DVD-Video, CVD, SVCD (super video CD), VCD (video CD), DVCD, CD, CD-R, CD-ROM, Picture CD and other types of optical disks. In another exemplary embodiment, DVD player 10 is capable of writing data to a recordable disk, e.g., DVD-R. The DVD player contains one or more video output ports and may also contain one or more audio output ports. The video and audio data read from the disk may be transmitted through the DVD player's audio and video output ports as video and audio signals, respectively.

DVD player 10 may be connected to display 15. Display 15 may be a television, monitor, video screen or any other similar display device. Display 15 is operable to display the video output from DVD player 10. Accordingly, DVD player 10 may output video or images from a disk to display 15 for viewing. If display 15 has a speaker, display 15 may also play the audio output from DVD player 10. If display 15 does not have a speaker or if the user requires better audio performance, then the user may connect the audio output ports of DVD player 10 to a separate audio system to hear the audio output from DVD player 10. As discussed above, a conventional DVD player may be connected to only display 15 and, perhaps, an audio system. Thus, the user of a conventional DVD player would be limited to playing or viewing movies from optical disk 50. However, the DVD player of the present invention is able to connect with a wide variety of additional devices and is therefore able to provide the user with additional functionality.

In one exemplary embodiment of the present invention, DVD player 10 also contains one or more USB ports 30. USB is a serial bus standard. Generally, USB connections attach personal computers to several types of devices, such as mice, modems, printers, digital cameras, keyboards and other peripherals. A USB connection delivers power to devices on the bus and thereby eliminates the need for separate power cords. USB, e.g., USB 1.0, for example, may provide a data rate of 12 megabits per second and support up to 127 devices. USB devices may support a hi-speed data transfer rate of up to 480 Mb/s but with a wide variation in edge rates, e.g., USB 2.0, for example. With typical line loads, full speed devices usually fall in the 12-25 ns range, and low-speed devices typically range 110-225 ns. USB is typically slower than FireWire, e.g., IEEE 1394 (Institute of Electrical and Electronics Engineers, Inc.), but it is less expensive to implement. USB also supports plug-and-play installation and hot plugging. The small size of a USB connection allows it to be used on smaller devices such as notebooks and handheld devices, for example. Accordingly, the addition of USB port 30 allows the user to connect DVD player 10 to a wider variety of devices than a conventional DVD player.

For instance, digital camera 20 may also be connected to DVD player 10. Digital camera 20 may be any camera device that stores pictures or video imagery on a digital memory location. Digital camera 20 is a USB device and may be connected to DVD player 10 via USB port 30. This connection allows digital camera 20 to send data to DVD player 10. A user may use digital camera 20 to capture images or video onto a memory location associated with the camera. The user may connect the digital camera 20 to DVD player 10 via USB port 30 to view the images or video from digital camera 20. As a result, the images and video captured by digital camera 20 may be viewed without the use of a computer system. The images or video from digital camera 20 may be stored on a memory location associated with DVD player 10. If the DVD player is able to write to a disk, then the images or video from digital camera 10 may be written to a recordable disk. Therefore, the images and video captured by digital camera 20 may be stored to a recordable disk without the use of a computer system.

Printer 25 may be connected to DVD player 10. Printer 25 may be a laser printer, ink-jet printer, photo printer or any other similar output device that can print graphics onto paper. Printer 25 is a USB device and may be connected to DVD player 10 via USB port 30. DVD player 10 may transmit video imagery to printer 25 for printing on paper. The images that DVD player 10 transmits to printer 25 may be from a disk or a memory location associated with the DVD player 10. If DVD player 10 contains two or more USB ports then DVD player 10 may output images from digital camera 20 to printer 25 while both devices are connected to DVD player 10. Thus, the images stored on the memory of digital camera 20 may be both viewed and printed via DVD player 10.

Other types of USB devices that are not shown in FIG. 1 may be connected to DVD player 10. For example, digital camcorders, scanners or any other imaging or video device may be connected to DVD player 10. If the digital camera stores images and video to a recordable disk, such as DVD-R or CDR, then the disk may be directly viewed from DVD player 10. Furthermore, images and video may be viewed from a memory location associated with the digital camcorder by connecting the digital camcorder to DVD player 10. Images may then be stored in a memory location associated with DVD player 10 or printed to printer 25. Similarly, if a scanner is connected to DVD player 10, then a scanned image may be viewed or written to disk from DVD player 10. In addition, hard drives, zip drives, or any other USB storage device may be connected to DVD player 10. DVD player 10 will be able to store and receive audio and video data, e.g., movies and images, from an attached USB storage device. In another exemplary embodiment, a device and DVD player 10 may share a common housing. For example, in one exemplary embodiment, DVD player 10 and printer 25 may be located within the same housing.

Devices that are not necessarily USB devices may also be attached to DVD player 10. In one exemplary embodiment, DVD player 10 may include a smart card slot 430 for interfacing with smart cards or memory sticks 455. In another exemplary embodiment, DVD player 10 may also incorporate a microphone port 440 to allow a microphone 460 to be connected to DVD player 10.

In another exemplary embodiment, DVD player 10 contains a network port 420 that allows DVD player 10 to connect to network 365. Network port 420 utilizes a network protocol, such as, for example, an Ethernet protocol, to transmit and receive data. DVD player 10 can receive audio and video data, e.g., movies and digital images, from other devices 450 attached to network 365 via network port 420. DVD player 10 may also send data to another network device 450. Network device 450 may be another DVD player 10, a database, a computer system, a digital camera or other digital audio/visual device, among other examples. Network 365 may be a LAN (local area network), WAN (wide area network), or any other type of network. As a result, DVD player 10 may receive audio/visual data from remotely located devices and is not limited to directly attached devices. Similarly, DVD player may also send audio/visual data to physically distant devices. For example, a user may connect digital camera 20 to DVD player 10 and send digital photographs to a network device 450 located in a distant location without the use of a computer system.

The DVD player of the present disclosure presents a number of advantages over conventional DVD players and computer systems. Because the presently disclosed DVD player 10 may incorporate a USB port, an Ethernet port or both, the functionality and connectivity of DVD player 10 are dramatically increased over conventional DVD players. DVD player 10 may be connected to a wide variety of USB devices such as printers, digital cameras and other multimedia devices. One advantage of this connectivity is that the user may view images and video from a wide variety of USB devices. For example, DVD player 10 may be connected to a digital camera and allow for images stored on the digital camera to be viewed on an external display unit such as a television. Another advantage is that DVD player 10 may transmit the images to an external device. For example, DVD player 10 may transmit a digital photograph to an external printer for printing. If DVD player 10 incorporates an Ethernet port, the user may view video or images over a network from remotely located devices attached to the network. As a result of the increased connectivity, the DVD player of the present invention, may become a hub for a home entertainment center, unlike conventional DVD players or computer systems.

Because DVD player 10 may be connected to television sets, the DVD player of the present invention allows a user to view digital photographs on a large-screen display rather than a smaller computer monitor. The use of a large-screen display allows several people to easily view the digital photographs at the same time. Furthermore, the DVD player of the present invention allows users to view and print digital photographs without the cost and complexity of a computer system. For example, the user avoids compatibility issues with conflicting software, waiting for the computer system to boot up, and other common disadvantages associated with a computer system. In addition, because television sets are typically located in living rooms or dens, several viewers may view the digital photographs in a more comfortable environment than that of a home office, where a computer system is generally located.

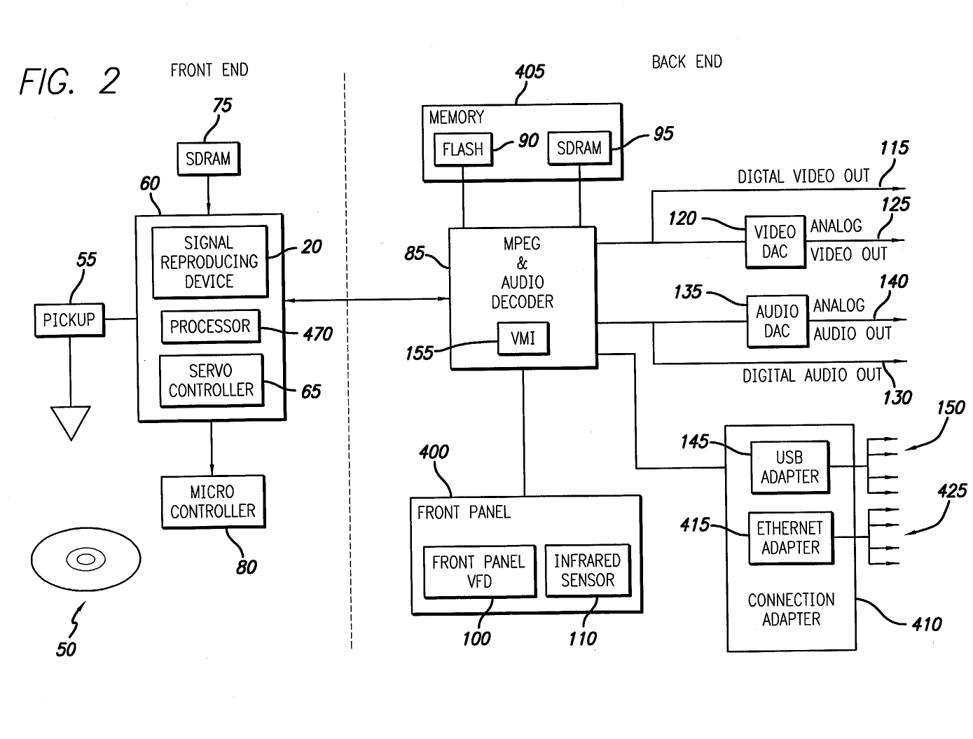

FIG. 2 shows a functional block diagram of an exemplary embodiment of DVD player 10. DVD player 10 reads may read information from disk 50. As discussed above, in one alternative embodiment, DVD player 10 may also write to disk 50 if disk 50 is a recordable disk. Generally, the components of DVD player are either front end components 40 or back end components 45. Front end components 40 are involved in reading information from disk 50. Back end components are involved in processing and outputting the data read from disk 50.

Disk 50 rotates at a predetermined speed by the rotation of a disk motor. A pickup 55 projects a laser light beam on the disk 50 to read data from the disk 50, receives the reflected light beam, and converts the reflected light beam into an analog RF (radio frequency) signal. Data reading device 60 contains signal reproducing device 70 and servo controller 65. Signal reproducing device 70 executes signal reproducing operations such as amplification of the RF signal output from pickup 55, noise elimination, conversion of the analog RF signal into a digital signal and synchronous detection. Servo controller 65 controls the rotation of disk 50 and the focusing and tracking of pickup 55 for an accurate readout of the data recorded on disk 50. A system controller or microcontroller 80 controls overall operations for reproduction of the data recorded on disk 50. A memory 75 is used as a track buffer. Memory 75 is connected to data processor or DSP (digital signal processor) 470 and stores the data processed therein. DSP 470 demodulates a signal input from the signal reproducing device 70, executes a phase control operation by a PLL (phase locked loop) device, and performs de-scrambling, error detection and correction, and memory control functions.

The back end components include a decoder device 85. Because data on disk 50 is compressed in an encoded format, decoder device 85 is used to convert the compressed and encoded data into video and audio signals. Accordingly, decoder device is connected to data reading device 60 to receive the data read from disk 50. Decoder device 85 serves as a video decoder to decode compressed video data from disk 50. For example, decoder device 85 may contain a MPEG (Motion Pictures Experts Group) video decoder for decoding video data compressed in an MPEG format, e.g., MPEG-1, MPEG-2, etc. Similarly, decoder device 85 serves as an audio decoder to decode compressed audio data from disk 50. For instance, decoder device 85 may include functionality for decoding compressed audio information stored in Dolby DTS, Dolby Digital or other type of audio format. One exemplary embodiment of decoder device 85 is the Vaddis V DVD decoder produced by Zoran Corporation of Santa Clara, Calif.

Decoder device 85 may be connected to memory 405. Memory 405 may contain one or more memory devices. For example, decoder device 85 may be connected to a flash memory 90. Software and firmware associated with DVD player 10 may be compiled and stored in flash memory 90. Decoder device 85 may also be connected to SDRAM (synchronous DRAM) 95. Software engines and applications may be placed in SDRAM 95.

Decoder device 85 is connected to the front panel 400 of DVD player 10. Front panel 400 includes front panel display 100 and IR (infrared) sensor 110. Front panel display 100 may be a VFD (vacuum fluorescent display) or any other suitable type of display. IR sensor 110 is used to receive IR remote control commands. These commands may then be sent to decoder device 85 to be decoded.

Decoder device 85 may transmit the decoded digital signal directly to an external device through digital video out 115. The decoded digital signal may be sent to video DAC (digital to analog converter) 120 to convert the decoded digital signal to an analog video signal. Decoder device 85 may transmit the decoded digital audio signal directly to an external device through digital audio out 130. Alternatively, audio DAC 135 converts the digital signal to an analog audio signal that may be sent to an external device via analog audio out 140.

Decoder device 85 includes or is connected to a VMI (video module interface) component 155. Generally, VMI 155 provides an interface between video modules and graphics modules. Examples of video modules include MPEG devices, video phones, and video decoders. Examples of graphics modules include GUI (graphical user interface) accelerators and ‘video ready’ graphics chips. Thus, VMI 155 is able to provide an interface between the decoder device and one or more external devices. VMI 155 generally provides a bidirectional high bandwidth connection for passing DVD data and video to and from the external devices. VMI 155 allows decoder device 85 to be connected to connection adapter device 410.

In one exemplary embodiment of the present invention, connection adapter device 410 may contain a USB adapter 145. USB adapter 145 allows DVD player 10 to contain one or more USB ports 150. USB adapter 145 provides an interface between a USB device and VMI 155. For example, a USB device may be connected to DVD player 10 via the USB port 30 provided by USB adapter 145. USB adapter is in turn connected to VMI 155. VMI 155 then passes the data to decoder 85 to be processed and sent to the audio and video outs 115-140. Accordingly, DVD player 10 may be connected to one or more USB devices, such as a digital camera and a printer, among other examples. As discussed above, the ability to connect to USB devices increases the functionality of DVD player 10 over conventional DVD players.

Connection adapter 410 may contain adapters directed to connection standards other than USB. For instance, connection adapter 410 may use connection standards such as the IEEE (Institute of Electrical and Electronics Engineers) 1394 standard, including FireWire, Lynx and i.link, for example. Other connection standards include SCSI (small computer system interface) and other bus or connection standards. Connection adapter 410 may also contain an adapter directed to a wireless connection or communications standard such as Bluetooth or the IEEE 802.11 wireless networking standard, among other examples. In this particular exemplary embodiment, connection adapter 410 provides a port that supports a wireless connection rather than a cable or similar physical interconnection. As a result, DVD player 10 may send data to and receive data from a wireless device, for example. In one exemplary embodiment, connection adapter 410 supports modular connectivity such that several different types of devices may be connected to a port 30.

In another exemplary embodiment of the present invention, connection adapter device 410 may contain an Ethernet adapter 415. Ethernet adapter 415 allows DVD player 10 to contain one or more Ethernet ports 420. As a result, DVD player 10 may be connected to network 365. With the Ethernet port, DVD player 10 may transmit to and receive data from other devices 450 that are connected to network 365. For example, DVD player 10 may receive images or video and audio signals from devices 450 connected to network 365. Similarly, DVD player 10 will be able to transmit images or video and audio signals to these network devices 450. Connection adapter device 410 may contain a network adapter directed to a network protocol other than an Ethernet protocol. Accordingly, connection adapter device 410 may contain a network adapter directed to other protocols that allow DVD player 10 to connect to network 365. In an exemplary embodiment, the network adapter may be directed to a wireless communications standard. For instance, as discussed above, connection adapter 410 may contain adapters for connection standards such as IEEE 802.11 or Bluetooth. In this exemplary embodiment, DVD player 10 may connect to network 365 via a wireless connection.

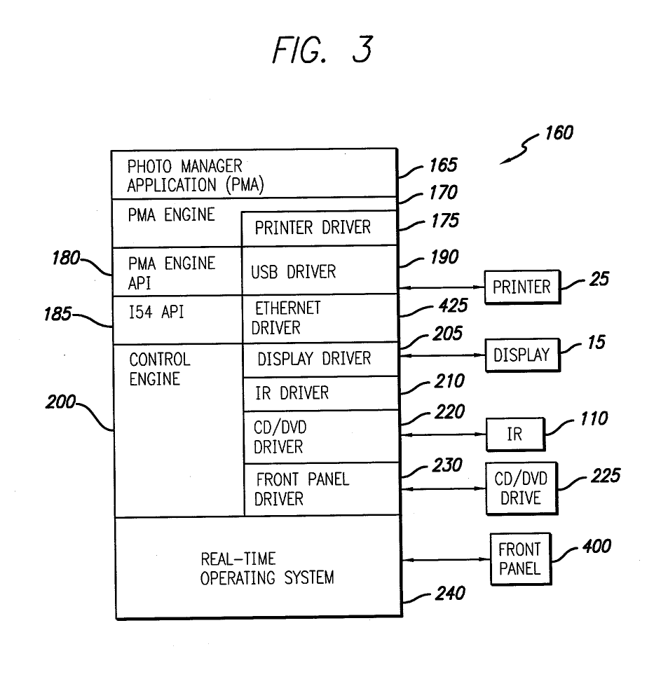

FIG. 3 shows an exemplary embodiment of the software structure 160 for DVD player 10. Software system 160 includes photo manager application 165. Photo manager application 165 allows the user to view, manipulate, edit, save and print selected digital photos or images from selected sources via DVD player 10. Photo manager application 165 provides a GUI based on HTML (Hyper Text Markup Language) or other type of graphics format. The user may navigate through the GUI using hardware controls such as an IR remote control or the controls available on front panel 400. Photo manager application 165 or hardware controls will allow the user to select the source of the digital photographs or images that the user wishes to view. As discussed above, a user may view digital photographs and images on display 15 from a number of sources via DVD player 10. For example, the digital photographs may be located on disk 50, a memory location associated with DVD player 10, an attached USB device, such as digital camera 20, a smart card 455 via smart card slot 430, or downloaded from network 365 via Ethernet port 420 to DVD player 10. Because DVD player 10 contains photo manager application 165, disk 50 does not need any software, such as an interface application, to allow a user to view digital images from disk 50. If a microphone 460 has been connected to DVD player 10 via microphone port 440, then the user may record an audio track, such as commentary for example, to accompany selected photos. The audio track may be stored in SDRAM 95, disk 50, or another storage or memory device. In one exemplary embodiment of the present invention, photo manager application 165 is the Planetweb Digital Photo Manager produced by Planetweb, Inc. of Redwood Shores, Calif.

Photo manager application engine 170 is a program that performs the core or essential function necessary to run photo manager application 165. Photo manager application engine 170 contain the code for the embedded processing of HTML, JS, user controls, graphic manipulation, display management, file management and peripheral interfaces. Photo manager application engine 170 may contain printer driver 175 to provide an interface between engine 170 and a printer device.

Software system 160 may also contain photo manager application engine API (application program interface) 180 and 154 API 185. The photo manager software components and the embedded processing and control engine 200 communicate through these API components. USB driver 190 exists in the common area between the APIs and allows the software structure to transmit print commands via a USB port to printer 25. Ethernet driver 425 also may exist in the common area between the API's and allows the software structure to support Ethernet protocol communications between DVD player 10 and network 365.

The control engine 200 software component allows for embedded processing and control of the DVD system hardware. For example, control engine 200 would be responsible for controlling the DVD chipset, flash and SDRAM memory components, peripheral interfaces, and other hardware. Control engine 200 utilizes a number of drivers to provide an interface between the hardware components and the software structure 160. Display driver 205 provides an interface between the software structure 160 and display 15. IR driver 210 allows for IR remote control commands received by IR sensor 110 to be processed by control engine 200. CD/DVD driver 220 allows control engine 200 to control the operation of the CD/DVD drive. Front panel driver 230 allows control engine 200 to control the display of information on front panel 400. Software system 160 is multi-threaded with the photo manager components as one processing thread and the control engine components as several processing threads to support independent hardware control. Software system 160 also contains real-time operating system 240 to manage and provide interfaces between the applications or programs in software system 160.

The components of software system 160 are generally stored in memory 405 and may be stored on flash memory 90 or SDRAM 95 depending on the nature of the software component. For example, the USB stack, which contains the USB connection protocols, may be compiled along with photo manager application 165 and the firmware for control engine 200 and placed in flash memory 90. A portion of photo manager application 165 may be placed in SDRAM 95.

Having thus described a preferred embodiment of the presently disclosed DVD player, it should be apparent to those skilled in the art that certain advantages of the described method and system have been achieved. It should also be appreciated that various modifications, adaptations, and alternative embodiments thereof may be made within the scope and spirit of the present invention. For example, DVD players with ports for handling communications in USB or Ethernet protocols have been illustrated, but it should be apparent that the inventive concepts described above would be equally applicable to other communications standards or protocols. The invention is further defined by the following claims.

What is claimed is:

1. A DVD player operable to read data from an optical disk, comprising:
an optical device adapted to project a laser beam onto a rotating optical disk and receive a reflected laser beam therefrom;
a servo controller adapted to control rotation of the optical disk;
a signal reproducing device adapted to reproduce a digital signal from the reflected laser beam;
a system controller coupled to the servo controller and the signal reproducing device to control the overall operation of the DVD player;
a decoder device to decode the digital signal into audio data and video data; and
a connection adapter operatively connected to the decoder device to provide a port operable to both transmit and receive digital communications between the DVD player and a device in accordance with a selected communications standard whereby the DVD player and the device are communicatively coupled.

2. The DVD player of claim 1, wherein the connection adapter comprises a USB adapter such that the port is operable to transmit and receive communications associated with a USB communications standard such that the DVD player may be communicatively coupled with a device operable to transmit and receive data in accordance with the USB standard.

3. The DVD player of claim 1, wherein the connection adapter comprises an IEEE 1394 adapter such that the port is operable to transmit and receive communications associated with an IEEE 1394 communications standard such that the DVD player may be communicatively coupled with a device operable to transmit and receive data in accordance with the IEEE 1394 standard.

4. The DVD player of claim 3, wherein the IEEE 1394 communications standard is a FireWire communications standard such that the DVD player may be communicatively coupled with a device operable to transmit and receive data in accordance with the FireWire standard.

5. The DVD player of claim 3, wherein the IEEE 1394 communications standard is a Lynx communications standard such that the DVD player may be communicatively coupled with a device operable to transmit and receive data in accordance with the Lynx standard.

6. The DVD player of claim 3, wherein the IEEE 1394 communications standard is an i.link communications standard such that the DVD player may be communicatively coupled with a device operable to transmit and receive data in accordance with the i.link standard.

7. The DVD player of claim 1, wherein the connection adapter comprises a SCSI adapter such that the port is operable to transmit and receive communications associated with a SCSI communications standard such that the DVD player may be communicatively coupled with a device operable to transmit and receive data in accordance with the SCSI standard.

8. The DVD player of claim 1, wherein the connection adapter comprises a wireless connection adapter, such that the port is operable to transmit and receive communications associated with a wireless communications standard such that the DVD player may be communicatively coupled with a device operable to transmit and receive data in accordance with the wireless standard.

9. The DVD player of claim 8, wherein the wireless communications standard is an IEEE 802.11 standard.

10. The DVD player of claim 8, wherein the wireless communications standard is a Bluetooth standard.

11. The DVD player of claim 1, wherein the connection adapter comprises a network adapter such that the port is operable to transmit and receive communications associated with a network communications standard whereby the DVD player may be communicatively coupled with a network operable to transmit and receive data in accordance with the network standard.

12. The DVD player of claim 11, wherein the network adapter comprises an Ethernet adapter such that the port is operable to transmit and receive communications associated with an Ethernet protocol.

13. The DVD player of claim 11 wherein the network adapter comprises a wireless connection adapter, such that the port is operable to transmit and receive communications associated with a wireless communications standard such that the DVD player may be communicatively coupled with the network via a wireless connection.

14. The DVD player of claim 13, wherein the wireless communications standard is an IEEE 802.11 standard.

15. The DVD player of claim 13, wherein the wireless communications standard is a Bluetooth standard.

16. The DVD player of claim 1, further comprising a video module interface (VMI) communicatively coupled to the connection adapter.

17. The DVD player of claim 1, further comprising a software agent operable to enable a user to view a digital image from an external device coupled to the DVD player via the port.

18. The DVD player of claim 17 wherein the DVD player further comprises a smart card slot operable to receive a smart card and thereby communicatively couple the smart card with the DVD player.

19. The DVD player of claim 18 wherein the software agent is further operable to enable a user to view a digital image from the smart card.

20. DVD player of claim 17 wherein the software agent is further operable to enable the user to manipulate the digital image.

21. The DVD player of claim 20, wherein the software agent is further operable to enable the user to save the digital image to a memory location.

22. The DVD player of claim 21, wherein the memory location is associated with an external device coupled to the DVD player via the port.

23. The DVD player of claim 21, wherein the software agent is further operable to enable the user to print the digital image from a printer device coupled to the DVD player via the port.

24. The DVD player of claim 23, wherein the DVD player further comprises a microphone port adapted to receive a microphone whereby the microphone may be communicatively coupled to the DVD player.

25. A video entertainment system comprising:
a video display operable to display video data;
a printer device operable to print an image; and
a DVD player operable to read data from an optical disk and transmit video data to the video display, comprising a connection adapter to provide a port operable to both transmit and receive digital communications between the DVD player and a device in accordance with a selected communications standard such that the DVD player and the device are communicatively coupled, wherein the printer device is communicatively coupled to the DVD player via the port such that the DVD player is operable to transmit an image to the printer device to be printed.

26. The video entertainment system of claim 25, wherein the connection adapter provides a plurality of ports.

27. The video entertainment system of claim 26, wherein the connection adapter comprises a USB adapter such that the port is operable to transmit and receive communications associated with a USB communications standard such that the DVD player may be communicatively coupled with a device operable to transmit and receive data in accordance with the USB standard.

28. The video entertainment system of claim 26, wherein the connection adapter comprises an IEEE 1394 adapter such that the port is operable to transmit and receive communications associated with a IEEE 1394 communications standard such that the DVD player may be communicatively coupled with a device operable to transmit and receive data in accordance with the IEEE 1394 standard.

29. The video entertainment system of claim 28, wherein the IEEE 1394 communications standard is a FireWire communications standard such that the DVD player may be communicatively coupled with a device operable to transmit and receive data in accordance with the FireWire standard.

30. The video entertainment system of claim 28, wherein the IEEE 1394 communications standard is a Lynx communications standard such that the DVD player may be communicatively coupled with a device operable to transmit and receive data in accordance with the Lynx standard.

31. The video entertainment system of claim 28, wherein the IEEE 1394 communications standard is an i.link communications standard such that the DVD player may be communicatively coupled with a device operable to transmit and receive data in accordance with the i.link standard.

32. The video entertainment system of claim 26, wherein the connection adapter comprises a SCSI adapter such that the port is operable to transmit and receive communications associated with a SCSI communications standard such that the DVD player may be communicatively coupled with a device operable to transmit and receive data in accordance with the SCSI standard.

33. The video entertainment system of claim 26, wherein the connection adapter comprises a wireless connection adapter, such that the port is operable to transmit and receive communications associated with a wireless communications standard such that the DVD player may be communicatively coupled with a device operable to transmit and receive data in accordance with the wireless standard.

34. The video entertainment system of claim 33, wherein the wireless communications standard is an IEEE 802.11 standard.

35. The video entertainment system of claim 33, wherein the wireless communications standard is a Bluetooth standard.

36. The video entertainment system of claim 26, wherein the connection adapter comprises a network adapter such that the port is operable to transmit and receive communications associated with a network communications standard whereby the DVD player may be communicatively coupled with a network operable to transmit and receive data in accordance with the network standard.

37. The video entertainment system of claim 36, wherein the network adapter comprises an Ethernet adapter such that the port is operable to transmit and receive communications associated with an Ethernet protocol.

38. The video entertainment system of claim 33, wherein the network adapter comprises a wireless connection adapter, such that the port is operable to transmit and receive communications associated with a wireless communications standard such that the DVD player may be communicatively coupled with the network via a wireless connection.

39. The video entertainment system of claim 38, wherein the wireless communications standard is an IEEE 802.11 standard.

40. The video entertainment system of claim 38, wherein the wireless communications standard is a Bluetooth standard.

41. The video entertainment system of claim 26, further comprising a video module interface (VMI) communicatively coupled to the connection adapter.

42. The video entertainment system of claim 41, further comprising a software agent operable to enable a user to view a digital image from an external device coupled to the DVD player via a port.

43. The video entertainment system of claim 42, wherein the DVD player further comprises a smart card slot operable to receive a smart card and thereby communicatively couple the smart card with the DVD player.

44. The video entertainment system of claim 43, wherein the software agent is further operable to enable a user to view a digital image from the smart card.

45. The video entertainment system of claim 42, wherein the software agent is further operable to enable the user to manipulate the digital image.

46. The video entertainment system of claim 45, wherein the software agent is further operable to enable the user to save the digital image to a memory location.

47. The video entertainment system of claim 46, wherein the memory location is associated with an external device coupled to the DVD player via the port.

48. The video entertainment system of claim 47, wherein the DVD player further comprises a microphone port adapted to receive a microphone whereby the microphone may be communicatively coupled to the DVD player.
